(19) United States
(12) Patent Application Publication
(10) Pub. No.: US 2026/0240364 A1
(43) Pub. Date: Aug. 20, 2026

(54) SPILL PROOF COOKWARE LID

(71) Applicant: Maryam Khavar, Laguna Niguel, CA (US)

(72) Inventor: Mahmoud Razzaghi, Laguna Niguel, CA (US)

(73) Assignee: Maryam Khavar, Laguna Niguel, CA (US)

(21) Appl. No.: 19/539,668

(22) Filed: Feb. 13, 2026

Related U.S. Application Data
(60) Provisional application No. 63/760,635, filed on Feb. 20, 2025.
(60) Provisional application No. 63/759,125, filed on Feb. 15, 2025.

(51) Int. Cl. A47J 36/06; A47J 27/58; A47J 36/38

(52) U.S. Cl. CPC A47J 36/06; A47J 27/58; A47J 36/38

(57) ABSTRACT

A spill-proof lid for a container and a covering system incorporating the lid are disclosed. The lid includes a covering wall extending across an open top of the container and a peripheral portion configured to engage a rim of the container to substantially close the container during use. At least one vent aperture communicates between an interior of the container and an exterior environment. The vent aperture has a size sufficiently small to disrupt foam bubbles generated during boiling. The covering wall includes a surface region extending toward the container interior and sloping toward the vent aperture, such that liquid released from disrupted foam bubbles is retained and returned to the container under gravity through the vent aperture. The lid remains seated on the container under its own weight while permitting controlled venting to inhibit spillover and may be reversible for spill-prevention and regular covering orientations.

### CROSS-REFERENCE TO RELATED APPLICATIONS

This non provisional patent application has priority date of provisional patent applications 63/759,125 filed 15 Feb 2025 and 63/760,635 filed 20 Feb 2025.

### PRIOR ART

Boiling food or water inside pots and pans with lids build up pressure which can lift the lid temporarily. After some steam is released from the opening created at the edge of the pot, pressure is relieved, and the lid drops back to its closed position. This may cause vibration and noise. To counter this issue, the lids are supplied with a vent hole in the periphery which has a diameter of 4 to 5 mm. However, food usually causes foam which still may push the lid and cause overflow over the pot lip and even the vent hole.

There are some spill proof devices for cookware in the market. One of these devices has a deformable silicone disc with a multiplicity of relatively large openings around the center with a detachable second flexible silicone piece having a central portion and a multiplicity of flaps loosely covering the openings. The disc is placed on the pot where it curves downward into a spherical shape. The middle of the disc stays lower than the edge of the pot. The foam generated in the pot reaches the bottom portion of the disc pushes the loose flaps up and enters the top side of the disc. The boiling extends to the top side of the disc as some bubbles break in the free colder air and new bubbles appear. This process maintains the foam in the pot below the edge of the pot and prevents spilling.

Another device is a silicon cylinder with a smaller diameter portion extending to a larger diameter portion through a shoulder. The smaller diameter portion goes into the pot, and the device is supported at the shoulder by the edge of the pot. The regular lid of the pot is placed over the pot into the larger diameter portion of the cylinder. Any foam overflowing the pot will be collected between the lid and the larger diameter portion of the cylinder.

It has also been suggested to keep the pot open and place a wooden spatula over it to break the foam and prevent spilling.

### BACKGROUND OF THE INVENTION

Spills waste part of the food, its taste, aroma, and nutrients besides creating a mess on the pot body and stove with burning of the spill and bad odors. Spill cannot be prevented by leaving the pot without a lid. Besides open boiling also evaporates aroma and excessive amounts of water which may cause drying and burning of the food if unattended.

The silicone disc device as described in the prior art, basically can only function in an open pot configuration. Otherwise, pressure will build up in the pot and reverses the curvature of the disc into an upward convex shape. Then, the foam reaches the pot edge before reaching the disc. Also, the pressure may lift the lightweight disc and spill over the edge of the pot. In fact, the whole benefit of the device is nothing more than that of the spatula over the open pot method.

Additionally, since bending downward is part of its functionality, the disc cannot be used as a regular cover for pots and pans. Especially, pans have a small depth, and their lids should be either flat or convex upward as is the case in all cookware.

Similarly, the cylindrical device described in prior art cannot be used as a normal lid and is also bulky.

Therefore, the purpose of the present invention is
1. To provide a spill proof lid that minimizes evaporation and loss of the contents of the pot and can also function as a regular lid.
2. To provide a spill proof lid that looks and functions like a regular lid, fully covering the pot and having only a few relatively small vents.

### SUMMARY OF THE INVENTION

A The present invention relates to a cookware pot assembly comprising a pot having a side wall, an open top with a lip, and a lid having a top wall and a peripheral rim. The lid includes at least one vent aperture having a diameter on the order of a few millimeters, sized to vent steam and to rupture foam bubbles generated within the pot during boiling. Upon rupture of the bubbles, liquid contained therein is returned to the pot through the aperture under gravity. The aperture is sufficiently small to prevent free flow of foam from the pot, thereby inhibiting boil-over. The lid substantially seals the pot except at the aperture and is retained in place by its own weight.

In one embodiment, the aperture is located at the apex of a downwardly sloping cavity formed in the top wall of the lid. Steam escapes upwardly from the cavity to the surrounding environment. Liquid from ruptured bubbles temporarily accumulates within the cavity and flows along the sloped surface back into the pot through the aperture under gravity.

In another embodiment, the pot includes an inwardly extending shoulder at its open top, and the lid is configured to sit within the pot and rest on the shoulder. The aperture is located at an interface between the lid and the pot shoulder. Steam escapes through the aperture and through a clearance between the lid rim and the pot side wall. Liquid from ruptured bubbles temporarily accumulates in the clearance region and returns to the pot through the aperture at the shoulder interface. The aperture has an open contour to permit unobstructed return of liquid over the shoulder into the pot and may be formed on a lower edge of the lid peripheral wall or on the pot shoulder.

The lid body may be formed of glass, ceramic, metal, silicone, or combinations thereof. The rim may be integral with the lid body or formed as a separate metal or silicone component attached thereto and may optionally include a silicone coating. The lid may further include two radially opposing handles, a radially extending handle, or a handle disposed on the top wall.

### BRIEF DESCRIPTION OF DRAWINGS

FIG. 1 is a sectional side view of the first embodiment of the invention.

FIG. 2 is a top view of the first embodiment of the invention with two side handles.

FIG. 3 is a top view of the first embodiment of the invention with an elongated handle.

FIG. 4 is the first embodiment of the invention covering a pot in spill proof configuration.

FIG. 5. is the first embodiment of the invention covering a pot in regular configuration.

FIG. 6 is a sectional side view of the second embodiment of the invention.

FIG. 7. is a sectional side view of the third embodiment of the invention.

FIG. 8 is a top view of the third embodiment of the invention.

FIG. 9 is a sectional side view of the fourth embodiment of the invention.

### DETAILED DESCRIPTION OF THE INVENTION

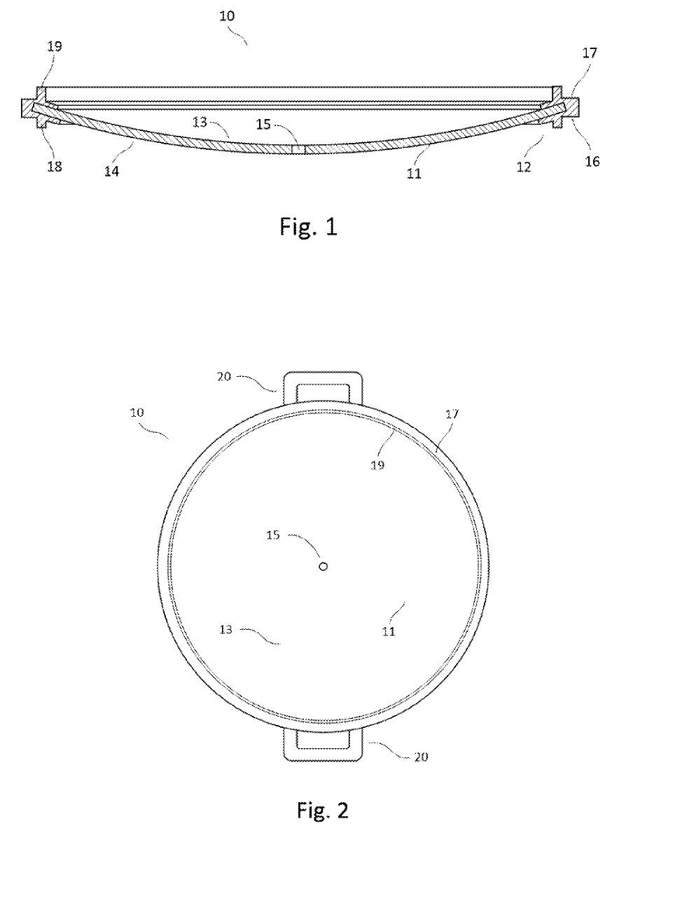

According to the first embodiment of the invention as shown in FIG. 1, there is a lid 10 to be used as cover for a pot or pan having a wall and an open top with a lip. Lid 10 has body 11 with rim 12, concave side 13, convex side 14, and hole 15. Hole 15 is at the center or apex of body 11 and has a preferred diameter of up to 6 mm. Projection 18 or 19 aligns lid 10 with the wall of the pot. Surface 16 or 17 contacts the lip of the pot to close it. Lid 10 has sufficient rigidity not to deform under its own weight or pot pressure during cooking. Body 11 material is glass, ceramic, metal or silicone. Rim 12 can be an integral part of body 11 or a metal or silicone part attached to it.

Due to venting through hole 15, the pressure inside the pot is slightly higher than the atmospheric pressure. The weight of a lid 10 is comparable to that of regular glass lid with a vent to maintain sealed closure between rim 12 and the pot lip. However, heavier lids are preferred. There are no safety concerns for building pressure inside the pot as in addition to venting through hole 15, if any excessive pressure develops lid 10 will temporarily lift under pressure and additional venting will occur.

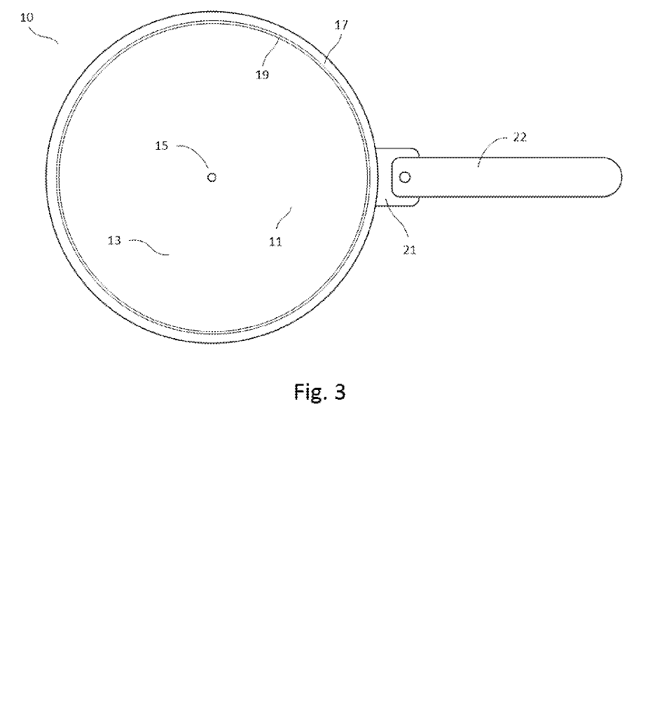

FIG. 2 shows a top view of Lid 10 with two radially opposing side handles 20. FIG. 3 shows a top view of Lid 10 with a radially extending elongated handle 22 attached to bracket 21, which may be an extension of or an attachment to body 11. The handles can be metal, Bakelite, glass, ceramic or silicone.

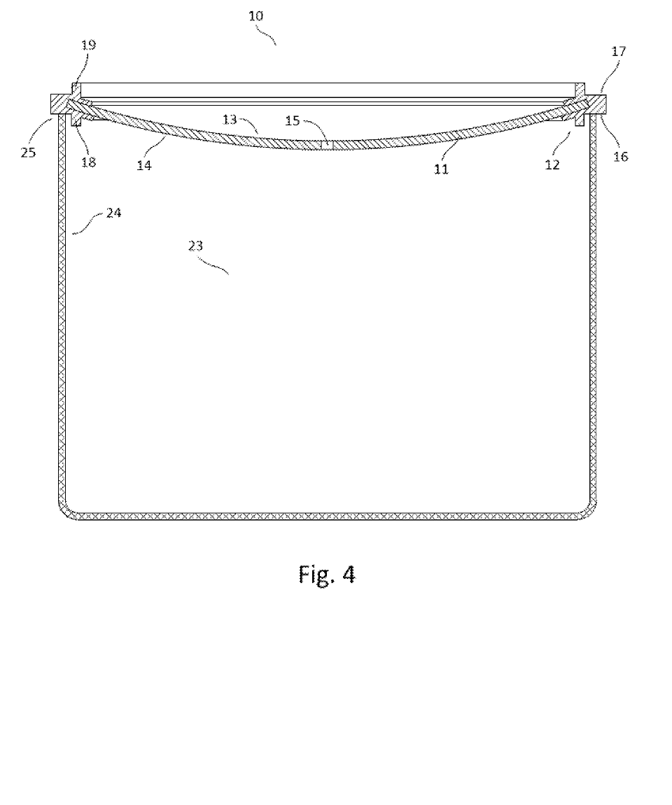

FIG. 4 shows the use of lid 10 with pot 23 in spill prevention configuration. Pot 23 has wall 24 with lip 25. Lid 10 is placed on pot 21 with concave side 13 upward. Projection 18 aligns lid 10 with pot wall 24. Surface 16 contacts pot lip 25. Surface 16 and pot lip 25 are smooth and create a seal under the weight of lid 10 against the water and steam inside pot 23. When the contents of pot 23 come to a boil and create excessive foam, the foam rises and reaches the lowest part of lid 10 first where hole 15 is located. As additional foam is generated, bubbles push through hole 15 and then burst as they expand in lower pressure air outside the pot. The water from burst bubbles pours onto concave side 13 near hole 15 and flows back through it under gravity into pot 23. This process essentially prevents accumulation of foam or water on lid 10 or spilling outside pot 23. At the same time, the pot is essentially closed as desired for cooking purposes.

In an experiment, using a regular 24 cm pot 23 and dome shaped glass lid 10, rice was boiled with water and oil at maximum heat. The central handle of the lid was removed to use the existing 8 mm hole as hole 15. The lid which had a stainless steel rim was placed on the pot with the concave side 13 upward. Although the rice water was relatively thick, only 10 ml of it accumulated on lid 10 steadily. This amount of water was only 2% of the capacity of lid 10. Although the seal between rim 12 of lid 10 and lip 25 of pot 23 was stainless steel over aluminum, and the cookware was used for a few years, the seal was still effective, and no rice water leaked over the pot. The 3 mm thick 530 g glass lid 10 was not lifted by the pressure inside pot 23 during the experiment.

In a similar experiment, milk was boiled at maximum heat. Milk foam freely flew through the 8 mm hole and filled the lid. When the hole size was reduced to 5.5 mm the foam broke and essentially no milk accumulated on the lid.

The preferable size of hole 15 is less than 6 mm to essentially break foam and prevent spills from all types of food. The relatively small size of hole 15 is an important aspect of the invention as it both breaks the foam bubbles as they generate inside pot 23 and minimizes undesirable evaporation from the pot. With a larger hole 15, the foam may freely flow out, accumulate over lid 10, and spill over. It should be noted that spills happen even in a fully open pot without any lid.

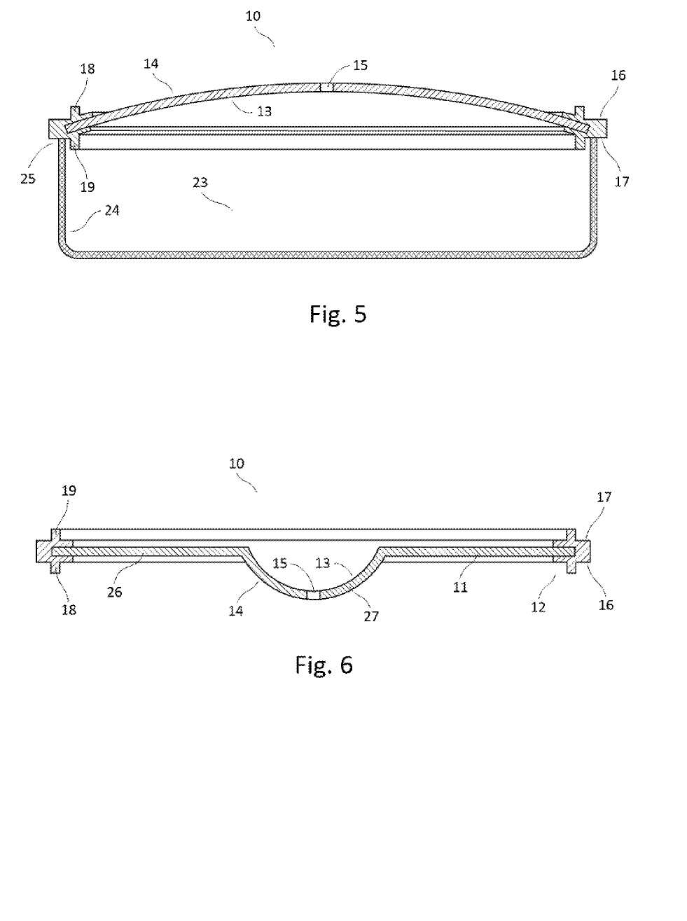

FIG. 5 shows the use of lid 10 with pot 23 in regular cooking configuration. Lid 10 with its convex side 14 facing upward is placed on pot 23. Projection 19 aligns lid 10 with pot wall 24. Surface 17 contacts pot lip 25. Surface 17 and pot lip 25 are smooth and create a seal under the weight of lid 10 against the water and steam inside pot 23. Hole 15 functions as a regular vent. This configuration allows full usage of the space inside pot 23 which is especially necessary for pans and low profile pots. Thus, the same lid 10 can be used in both spill prevention and regular cooking configurations.

The second embodiment of the invention, FIG. 6, is like the first embodiment but with a different shape of body 11. Body 11 has a flat peripheral portion 26 and a cavity 27 at the center of body 11 with hole 15 at its apex. Cavity 27 extends to the same depth and functions the same as lid 10 of the first embodiment but occupies less volume inside the pot. Additionally, cavity 27 has a steeper concave side 13 compared to that of the first embodiment which returns the water faster to pot 23. Therefore, even less water accumulates around hole 15. The preferred diameter range of cavity 27 is 6-10 cm or one third the diameter of lid 10.

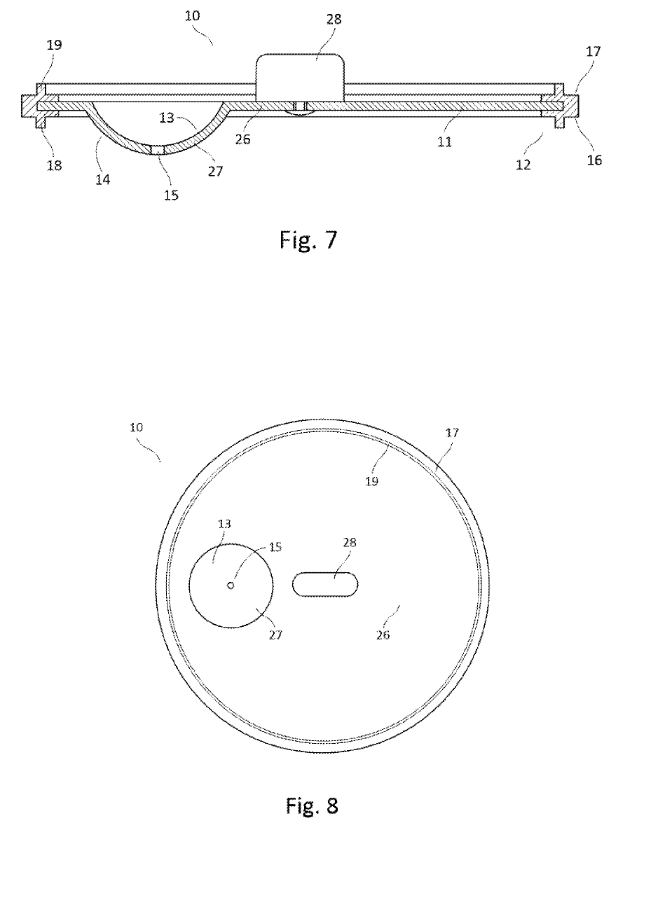

The third embodiment of the invention, FIGS. 7 and 8, is like the second embodiment but with cavity 27 at the periphery of body 11. Peripheral position of cavity 27 helps reduce its interference with solid contents of pot 23 which usually reach their max height around the center of pot 23. Therefore, the same configuration for spill prevention can also be used for normal cooking and a central handle 28 can be used for lid 10 instead of side handles. Projection 19 is not needed but it may be kept for containing any probable overflow from cavity 27.

In the third embodiment of the invention, portion 26 is preferably flat but it can also have the same curvature as in the first embodiment of the invention or regular lids in the market. The reason is that at the periphery, the height of portion 26 would be relatively small with only minor effect on the overall shape and function of lid 10. In other words, the third embodiment changes a regular pot lid with a peripheral vent to a spill proof lid by adding a downward projection around the vent.

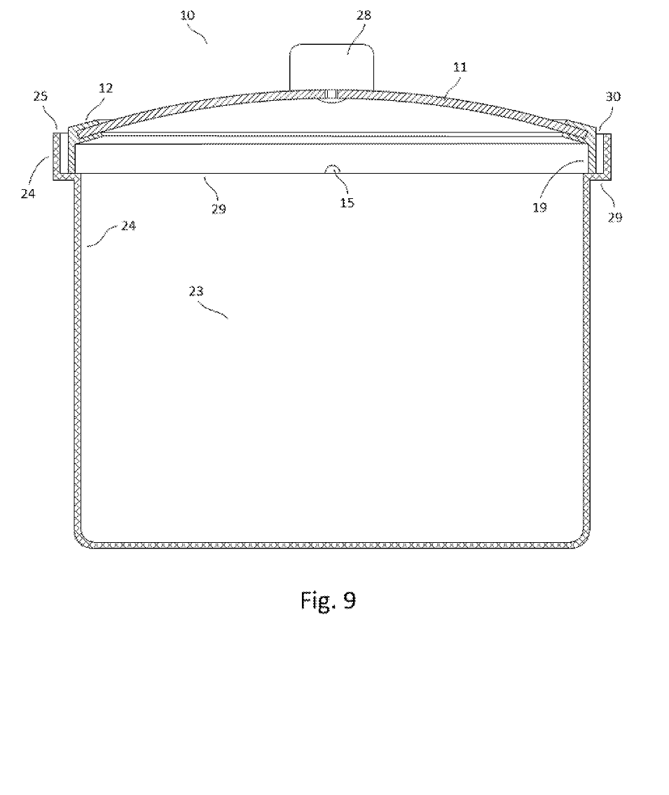

In the fourth embodiment of the invention, FIG. 9, pot 23 has wall 24, lip 25 and lid 10. Wall 24 extends to a larger diameter at shoulder 29 below lip 25. Lid 10 has body 11, handle 28, and rim 12 with projection 19. Projection 19 has aperture 15 with an open contour at its edge. Lid 10 sits on shoulder 29 such that projection 19 interfaces shoulder 29 and seals pot 23 except at aperture 15. There is radial clearance 30 between Lid 10 at rim 12 and pot wall 24 above shoulder 29. Radial projections on rim 12 may be used to center the position of lid 10 relative to pot wall 24 for a uniform clearance 30 around lid 10. Foam bubbles from inside pot 23 exit through aperture 15 and break. The steam vents away through clearance 30. The water from broken foam accumulates temporarily in clearance 30 and returns to pot 23 through the same aperture 15. The preferred range for radial clearance 30 is 3-6 mm.

The size of the apertures is sufficiently small such that foam bubbles break when passing through them. The preferred range of area value for aperture 15 is 10-25 mm². Two or more apertures may be used, preferably symmetrically around projection 19. However, preferably the apertures are smaller than a single aperture to prevent excessive venting of pot 23. Apertures may be shaped like a sinusoidal wave. The preferred height of wall 24 above shoulder 29 is 10-20 mm.

Manufacturing the lid in the fourth embodiment of the invention is simple and practical both in casting and forming. Also, the apertures do not make any noticeable change in the appearance of the lid and are invisible during cooking. The fourth embodiment provides a flexible design that can be applied to all types of pots and pans with different materials, styles, and sizes.

In any of the foregoing embodiments, instead of a single aperture 15, a plurality of apertures 15 may be provided in body 11. The apertures 15 may be distributed symmetrically or asymmetrically and may be identical or different in size. In another alternative, body 11 may include a generally annular groove formed near rim 12, with one or more apertures 15 opening through the groove to provide distributed venting while maintaining bubble-breaking functionality.

Sealing between lid 10 and pot 23 at the lid–pot interface may be achieved in various ways. In one configuration, rim 12 includes a silicone layer or coating that contacts lip 25 or shoulder 29 of pot 23. In another configuration, sealing is achieved by direct contact between smooth, matching flat or conical surfaces on rim 12 and the corresponding surface of pot 23, with sealing maintained primarily by the weight of lid 10.

1. A spill-proof covering system, comprising:
a container having an interior defined by a bottom wall, a side wall, and an open top defined by a peripheral rim;
a lid configured to span the open top and substantially close the container during use, the lid comprising:
a covering wall extending across the open top of the container;
a peripheral portion configured to engage the peripheral rim of the container;
the system includes at least one vent aperture communicating between the interior of the container and an exterior environment;
the vent aperture has a size sufficiently small to disrupt foam bubbles generated within the container during boiling;
wherein the lid and the container cooperate to retain liquid released from disrupted foam bubbles and return the liquid to the container under gravity; and
the lid is configured to remain seated on the container under its own weight while permitting controlled venting through the vent aperture to inhibit spillover.

2. The system of claim 1, wherein the vent aperture is formed through the covering wall.

3. The system of claim 2, wherein the covering wall includes a downwardly recessed region extending toward the container interior, the vent aperture is located at an apex of the recessed region, and the recessed region is configured to direct returned liquid toward the vent aperture.

4. The system of claim 3, wherein the recessed region is located centrally within the covering wall.

5. The system of claim 3, wherein the recessed region is located adjacent the peripheral portion of the covering wall.

6. The system of claim 1, wherein the vent aperture is formed at an interface between the peripheral portion of the lid and the container.

7. The system of claim 6, wherein the container includes a shoulder below the peripheral rim, and the peripheral portion of the lid is supported on the shoulder such that the vent aperture is defined at the interface between the peripheral portion and the shoulder.

8. The system of claim 7, wherein a radial clearance is provided between the peripheral portion of the lid and the side wall of the container above the shoulder to permit venting of steam, temporarily retain liquid released from disrupted foam bubbles, and return the liquid to the container under gravity through the vent aperture.

9. The system of claim 1, wherein the vent aperture has a transverse dimension of up to 6 mm.

10. The system of claim 1, wherein the vent aperture has an area of up to 30 mm².

11. The system of claim 1, wherein the system includes two or more vent apertures.

12. The system of claim 1, wherein the lid is reversible, such that the covering wall is operable in a spill-prevention orientation and in a regular covering orientation.

13. A spill-proof lid for a container, comprising:
a substantially rigid body sized to span an opening of the container;
a peripheral portion configured to rest on or engage a rim of the container to substantially close the container during use; and
at least one vent aperture extending through the body and communicating between an interior of the container and an exterior environment;
the vent aperture has a transverse dimension sufficiently small to disrupt foam bubbles generated within the container as the foam bubbles pass through the vent aperture;
the covering wall includes a downwardly recessed cavity extending toward the container interior, having an apex at the vent aperture, and the recessed cavity is configured to temporarily receive liquid released from disrupted foam bubbles and to direct the liquid back into the container through the same vent aperture under gravity; and
the lid is configured to remain seated on the container under its own weight without substantial deformation during boiling while permitting controlled venting to inhibit spillover.

14. The spill-proof lid of claim 13, wherein the recessed cavity is located centrally within the covering wall.

15. The spill-proof lid of claim 13, wherein the recessed cavity is located adjacent the peripheral portion of the covering wall.

16. The spill-proof lid of claim 13, wherein the vent aperture has an area up to 30 mm².

17. The spill-proof lid of claim 13, wherein the body is formed from glass, ceramic, metal, rigid silicone, or combinations thereof.

18. The spill-proof lid of claim 13, wherein the lid is reversible and usable in a spill-prevention orientation and a regular covering orientation.

19. The spill-proof lid of claim 13, further comprising one or two handles coupled to the lid, the handles extending radially outward from the lid or transversely relative to the covering wall to facilitate handling of the lid.

20. The spill-proof lid of claim 19, wherein at least one handle extending transversely relative to the covering wall has an inverted U shape positioned over the vent aperture, the inverted U shape being configured to intercept splashes generated by foam bubbles breaking at the vent aperture.
